(19) United States
(12) Patent Application Publication
(10) Pub. No.: US 2024/0119604 A1
(43) Pub. Date: Apr. 11, 2024

(54) METHOD OF CONTROLLING ELECTRONIC DEVICE BY USING SPATIAL INFORMATION AND ELECTRONIC DEVICE USING SPATIAL INFORMATION

(71) Applicant: Samsung Electronics Co., Ltd., Suwon-si (KR)

(72) Inventors: Dongchan KIM, Suwon-si (KR); Dongnam BYUN, Suwon-si (KR); Jaewook SHIN, Suwon-si (KR); Jinyoung HWANG, Suwon-si (KR); Sejin KWAK, Suwon-si (KR); Geunho LEE, Suwon-si (KR)

(21) Appl. No.: 18/364,901

(22) Filed: Aug. 3, 2023

Related U.S. Application Data
(63) Continuation of application No. PCT/KR2023/010655, filed on Jul. 24, 2023.

(30) Foreign Application Priority Data
Oct. 7, 2022 (KR) 10-2022-0129054
Nov. 9, 2022 (KR) 10-2022-0148977

(51) Int. Cl. G06T 7/20; B25J 9/16; G06T 7/70; G06T 17/05

(52) U.S. Cl. CPC G06T 7/20; B25J 9/1664; G06T 7/70; G06T 17/05; G06T 2207/20101; G06T 2207/30241; G06V 2201/07

(57) ABSTRACT

A method of controlling an electronic device by using spatial information and an electronic device using spatial information are provided. The method includes selecting, based on spatial information about a space including at least one object and a task that the electronic device is set to perform, an object that obstructs the task from among objects located in a space corresponding to the task, providing a user of the electronic device with object movement guide information corresponding to attribute information about the selected object, determining a movement path used to perform the task, based on a user's response corresponding to the object movement guide information, and driving the electronic device according to the determined movement path.

### CROSS-REFERENCE TO RELATED APPLICATION(S)

This application is a continuation application, claiming priority under § 365(c), of an International application No. PCT/KR2023/010655, filed on Jul. 24, 2023, which is based on and claims the benefit of a Korean patent application number 10-2022-0129054, filed on Oct. 7, 2022, in the Korean Intellectual Property Office, and of a Korean patent application number 10-2022-0148977, filed on Nov. 9, 2022, in the Korean Intellectual Property Office, the disclosure of each of which is incorporated by reference herein in its entirety.

### TECHNICAL FIELD

The disclosure relates to a method of controlling an electronic device by using spatial information and an electronic device using spatial information.

### BACKGROUND ART

The Internet has evolved from a human-centered connection network, in which humans create and consume information, to the Internet of Things (IoT) network in which dispersed components such as objects exchange information with one another to process the information. Internet of Everything (IoE) technology has emerged, in which the IoT technology is combined with, for example, technology for processing big data through connection with a cloud server or the like. The IoT may be applied to various fields such as smart home appliances, smart homes, smart buildings, smart cities, etc., through convergence and integration between existing information technology (IT) and various industries.

Electronic devices interconnected in an IoT environment may each collect, generate, analyze, or process data, and share the data with each other so that it may be used to accomplish a task on each device. Recently, with rapid advances in the field of computer vision, various types of electronic devices that use neural network models to perform vision tasks have been developed. Accordingly, there is a growing interest in connection between various types of electronic devices in the IoT environment.

The above information is presented as background information only to assist with an understanding of the disclosure. No determination has been made, and no assertion is made, as to whether any of the above might be applicable as prior art with regard to the disclosure.

### DESCRIPTION OF EMBODIMENTS

### Technical Solution to Problem

An embodiment of the disclosure is to address at least the above-mentioned problems and/or disadvantages and to provide at least the advantages described below. Accordingly, an embodiment of the disclosure is to provide a method of controlling an electronic device by using spatial information and an electronic device using spatial information.

An embodiment of the disclosure will be set forth in part in the description which follows and, in part, will be apparent from the description, or may be learned by practice of the presented embodiments.

According to an embodiment of the disclosure, a method of controlling an electronic device by using spatial information is provided. The method includes, based on spatial information about a space including at least one object and a task that the electronic device is set to perform, selecting an object that obstructs the task from among objects located in a space corresponding to the task. Furthermore, the method of controlling the electronic device by using spatial information includes providing a user of the electronic device with object movement guide information corresponding to attribute information about the selected object. Furthermore, the method of controlling the electronic device by using spatial information includes determining a movement path used to perform the task, based on a user's response corresponding to the object movement guide information. Furthermore, the method of controlling the electronic device by using spatial information includes driving the electronic device according to the determined movement path.

According to an embodiment of the disclosure, a non-transitory computer-readable recording medium having recorded thereon a program for executing the above-described method is provided.

According to an embodiment of the disclosure, an electronic device using spatial information is provided. The electronic device includes a memory storing one or more instructions, a processor configured to execute the one or more instructions stored in the memory, and a sensor unit. The processor is configured to execute the one or more instructions to, based on spatial information about a space including at least one object, which is obtained via the sensor unit, and a task that the electronic device is set to perform, select an object that obstructs the task from among objects located in a space corresponding to the task. The processor is configured to execute the one or more instructions to provide a user of the electronic device with object movement guide information corresponding to attribute information about the selected object. The processor is configured to execute the one or more instructions to determine a movement path used to perform the task, based on a user's response corresponding to the object movement guide information. The processor is configured to execute the one or more instructions to drive the electronic device according to the determined movement path.

Aspects, advantages, and salient features of the disclosure will become apparent to those skilled in the art from the following detailed description taken in conjunction with the annexed drawings.

### BRIEF DESCRIPTION OF DRAWINGS

The above and other aspects, features, and advantages of an embodiment of the disclosure will be more apparent from the following description taken in conjunction with the accompanying drawings, in which:

FIG. 1 is a diagram for describing an in-house Internet of Things (IoT) environment in which an electronic device is interconnected to external devices according to an embodiment of the disclosure;

FIGS. 2A and 2B are flow diagrams for describing a spatial map according to an embodiment of the disclosure;

FIGS. 3A, 3B, 3C, and 3D are diagrams for describing a method of utilizing layers constituting a spatial map according to an embodiment of the disclosure;

FIG. 4 is a flowchart of a method of obtaining a spatial map, according to an embodiment of the disclosure;

FIG. 5 is a flowchart of a method of controlling an electronic device by using spatial information, according to an embodiment of the disclosure;

FIG. 6 is a detailed flowchart illustrating an operation of selecting an object obstructing a task from among objects located in a space corresponding to the task, according to an embodiment of the disclosure;

FIG. 7 is a detailed flowchart illustrating an operation of providing object movement guide information corresponding to attribute information about an object selected as an object obstructing a task, according to an embodiment of the disclosure;

FIG. 8 is a diagram for describing a first movement request process according to an embodiment of the disclosure;

FIG. 9 is a diagram for describing an example of providing object movement guide information to a user, according to an embodiment of the disclosure;

FIG. 10 is a diagram for describing another example of providing object movement guide information to a user, according to an embodiment of the disclosure;

FIG. 11 is a diagram for describing a second movement request process according to an embodiment of the disclosure;

FIG. 12 is a diagram for describing a process of selecting candidate positions to which a selected object is to be moved, according to an embodiment of the disclosure;

FIG. 13 is a diagram for describing an example of providing a user with object movement guide information according to an image evaluation result, according to an embodiment of the disclosure;

FIG. 14 is a detailed flowchart illustrating an operation of determining a movement path used to perform a task, according to an embodiment of the disclosure; and

FIGS. 15 and 16 are block diagrams illustrating the configuration of an electronic device using spatial information, according to an embodiment of the disclosure.

The same reference numerals are used to represent the same elements throughout the drawings.

### MODE OF DISCLOSURE

The following description with reference to the accompanying drawings is provided to assist in a comprehensive understanding of an embodiment of the disclosure as defined by the claims and their equivalents. It includes various specific details to assist in that understanding but these are to be regarded as merely exemplary. Accordingly, those of ordinary skill in the art will recognize that various changes and modifications of the an embodiment described herein can be made without departing from the scope and spirit of the disclosure. In addition, descriptions of well-known functions and constructions may be omitted for clarity and conciseness.

Terms and words used in the following description and claims are not limited to the bibliographical meanings, but, are merely used by the inventor to enable a clear and consistent understanding of the disclosure. Accordingly, it should be apparent to those skilled in the art that the following description of an embodiment of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the disclosure, the expression “at least one of a, b or c” indicates only a, only b, only c, both a and b, both a and c, both b and c, all of a, b, and c, or variations thereof.

The terms used in the disclosure are general terms currently widely used in the art based on functions described in the disclosure, but may be changed according to an intention of a technician engaged in the art, precedent cases, advent of new technologies, etc. Furthermore, specific terms may be arbitrarily selected by the applicant, and in this case, the meaning of the selected terms will be described in detail in the detailed description of the disclosure. Thus, the terms used herein should be defined not by simple appellations thereof but based on the meaning of the terms together with the overall description of the disclosure.

All the terms used herein, which include technical or scientific terms, may have the same meaning that is generally understood by a person of ordinary skill in the art. Furthermore, although the terms including an ordinal number such as “first”, “second”, etc. may be used herein to describe various elements or components, these elements or components should not be limited by the terms. The terms are only used to distinguish one element or component from another element or component.

Throughout the specification, when a part “includes” or “comprises” an element, unless there is a particular description contrary thereto, it is understood that the part may further include other elements, not excluding the other elements. In addition, terms such as “portion”, “module”, etc., described in the specification refer to a unit for processing at least one function or operation and may be implemented as hardware or software, or a combination of hardware and software.

Functions related to artificial intelligence (AI) according to the disclosure are performed via a processor and a memory. The processor may be configured as one or more processors. In this case, the one or more processors may be a general-purpose processor such as a central processing unit (CPU), an application processor (AP), a digital signal processor (DSP), etc., a dedicated graphics processor such as a graphics processing unit (GPU), a vision processing unit (VPU), etc., or a dedicated AI processor such as a neural processing unit (NPU). The one or more processors control input data to be processed according to predefined operating rules or AI model stored in the memory. Alternatively, when the one or more processors are a dedicated AI processor, the dedicated AI processor may be designed with a hardware structure specialized for processing a particular AI model.

The predefined operation rules or AI model are created via a training process. In this case, the creation via the training process means that the predefined operation rules or AI model set to perform desired characteristics (or purposes) are created by training a basic AI model based on a large number of training data via a learning algorithm. The training process may be performed by an apparatus itself in which AI is performed or via a separate server and/or system. Examples of a learning algorithm may include, but are not limited to, supervised learning, unsupervised learning, semi-supervised learning, and reinforcement learning.

An AI model may consist of a plurality of neural network layers. Each of the plurality of neural network layers has a plurality of weight values and may perform neural network computations via calculations between a result of computations in a previous layer and the plurality of weight values. A plurality of weight values assigned to each of the plurality of neural network layers may be optimized by a result of training the AI model. For example, the plurality of weight values may be updated to reduce or minimize a loss or cost value obtained in the AI model during a training process. An artificial neural network may include a deep neural network (DNN), and may be, for example, a convolutional neural network (CNN), a DNN, a recurrent neural network (RNN), a restricted Boltzmann machine (RBM), a deep belief network (DBN), a bidirectional recurrent DNN (BRDNN), or deep Q-networks (DQNs) but is not limited thereto.

An embodiment of the disclosure will now be described more fully hereinafter with reference to the accompanying drawings so that the embodiment be easily implemented by one of ordinary skill in the art. However, the disclosure may be implemented in different forms and should not be construed as being limited to an embodiment set forth herein.

Hereinafter, the disclosure is described in detail with reference to the accompanying drawings.

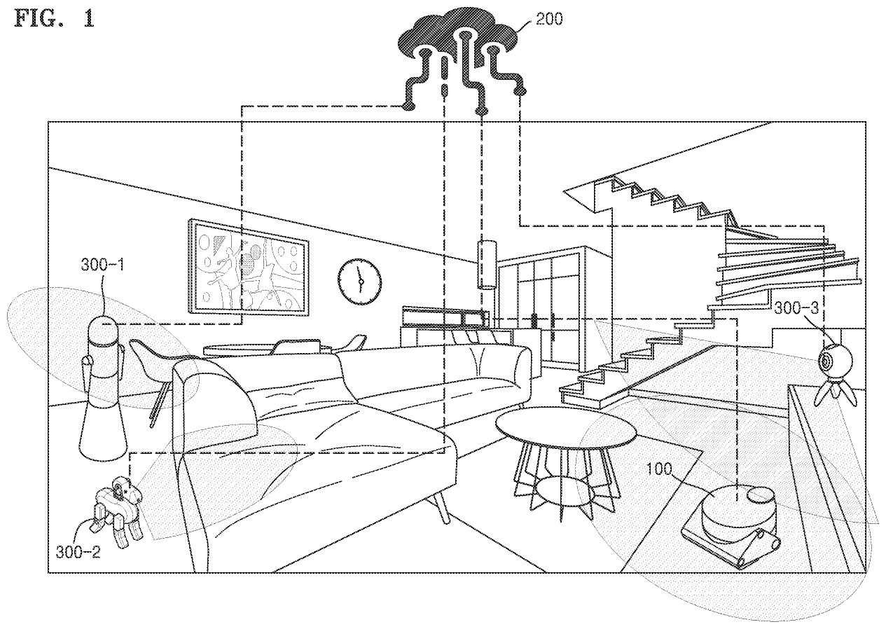

FIG. 1 is a diagram for describing an in-house IoT environment in which an electronic device 100 is interconnected to external devices according to an embodiment of the disclosure.

In the disclosure, the electronic device 100 is described as a robot cleaner, but it may be any type of assistant robot or mobile device driven for user convenience, an augmented reality (AR) device, a virtual reality (VR) device, or a device may be a device that senses a surrounding environment and provides a certain service in a particular position or space. The electronic device 100 may be equipped with various types of sensors and neural network models for scanning a space and detecting objects in the space. For example, the electronic device 100 may include at least one of an image sensor such as a camera, a light detection and ranging (LiDAR) sensor such as a laser distance sensor (LDS), or a time-of-flight (ToF) sensor. The electronic device 100 may include at least one model such as a DNN, a CNN, an RNN, and a BRDNN, or any combination thereof.

External devices interconnected to the electronic device 100 may be a cloud server 200 and various types of Internet of Things (IoT) devices (300-1, 300-2, and 300-3).

Referring to FIG. 1, the IoT devices may be, but are not limited to, a butler robot 300-1, a pet robot 300-2, a smart home camera 300-3, etc., and may be devices of the same type as the electronic device 100. The butler robot 300-1, the pet robot 300-2, and the smart home camera 300-3 may each use various types of sensors formed therein to scan the space and detect objects in the space.

According to an embodiment of the disclosure, the electronic device 100, the butler robot 300-1, the pet robot 300-2, and the smart home camera 300-3 may each use spatial scan information or object information collected therefrom to generate and store a spatial map as spatial information about a space that includes at least one object. The electronic device 100, the butler robot 300-1, the pet robot 300-2, and the smart home camera 300—may transmit or receive pieces of spatial scan information or object information, or spatial maps to or from each other and store them, thereby being able to share them with each other.

Because devices even within the same space scan the space and detect objects from different angles of view at different times, depending on a location of each of the devices, the performance or sensing range of each device, whether each device is stationary or mobile, a behavior of each device, etc., sensing information including an image or audio obtained from one device may be usefully used to train AI models loaded in other devices.

According to an embodiment of the disclosure, any one of the electronic device 100, the butler robot 300-1, the pet robot 300-2, and the smart home camera 300-3 may be a master device or server device, and the remaining devices may be slave devices or client devices. A device corresponding to a master device or a server device may receive pieces of spatial scan information or object information, or spatial maps from other IoT devices and store and manage them. The device corresponding to the master device or server device may classify, store, and manage the received pieces of information by location. For example, the device corresponding to the master device or server device may classify, collect, and manage the received pieces of spatial scan information or object information or spatial maps according to whether the received pieces of information is about the same space, the same zone, or the same region. The device corresponding to the master device or server device may update stored first information with second information corresponding to the same location, thereby maintaining up-to-dateness and accuracy of information related to the corresponding location.

According to an embodiment of the disclosure, the electronic device 100, the butler robot 300-1, the pet robot 300-2, and the smart home camera 300-3 may transmit pieces of their spatial scan information or object information or spatial maps to the cloud server 200, so that the pieces of spatial scan information or object information or the spatial maps may be stored and managed via the cloud server 200. For example, when the IoT devices are not able to transmit the spatial scan information or object information or spatial maps to the electronic device 100 because the IoT devices are powered off or are executing particular functions, the electronic device 100 may request and receive the spatial scan information or object information, or spatial maps from the cloud server 200.

Referring to FIG. 1, the cloud server 200 may manage the pieces of spatial scan information or object information or spatial maps respectively received from the electronic device 100, the butler robot 300-1, the pet robot 300-2, and the smart home camera 300-3, and monitor a space in a house. The cloud server 200 may store and manage the pieces of spatial scan information or object information or spatial maps respectively collected from the plurality of IoT devices for each registered user account or registered position. For example, the cloud server 200 may classify, collect, and manage the pieces of spatial scan information or object information or spatial maps from the IoT devices according to whether they are in the same space or the same zone. The cloud server 200 may transmit information about the space in the house, such as a spatial map, in response to requests from the electronic devices 100, the butler robot 300-1, the pet robot 300-2, and the smart home camera 300-3 located in the house.

According to an embodiment of the disclosure, instead of the cloud server 200, an AI hub (e.g., an AI speaker) located in the house may receive pieces of spatial scan information or object information or spatial maps from IoT devices in the house and store and manage them. The AI hub may store and manage the pieces of spatial scan information or object information or spatial maps collected from a plurality of IoT devices by space or zone in the house.

According to an embodiment of the disclosure, the AI hub located in the house may store and manage pieces of spatial scan information or object information or spatial maps in conjunction with the cloud server 200. For example, the AI hub may process pieces of spatial scan information or object information in order to generate or manage spatial maps, or convert data to protect personal information and transmit the data to the cloud server 200. The cloud server 200 may process information received from the AI hub to store and manage the pieces of spatial scan information or object information or spatial maps, and transmit them to the AI hub.

According to an embodiment of the disclosure, the electronic device 100 such as a robot cleaner may use a spatial map to perform a task such as cleaning. To accomplish this, the electronic device 100 may scan a space by using various types of sensors and update the spatial map with latest spatial scan information. The electronic device 100 may update the spatial map stored in the electronic device 100 by using not only the directly sensed information but also some or all of the spatial maps received from the cloud server 200, the butler robot 300-1, the pet robot 300-2, and the smart home camera 300-3, which are interconnected in the in-house IoT environment.

For example, to clean a space in the house, a robot cleaner may perform cleaning by using a spatial map stored in the robot cleaner when charging is completed at a charging station. The robot cleaner may use the same spatial map as recently used in order to clean the same space. However, since a state of the space at the time of previous cleaning is different from a current state of the space, it is desirable to reflect latest information about objects located in the space in the spatial map in order to perform efficient cleaning. To this end, starting from a charging station, the robot cleaner may travel in advance along a main route to directly collect information about objects in the space. However, when the robot cleaner travels in advance, further time may be required for the traveling in advance, and the battery may be further consumed due to such advance traveling. In this case, the robot cleaner may update the spatial map stored in the robot cleaner by receiving a latest spatial map from another robot cleaner or at least one external device located in the same space.

The robot cleaner may utilize a part of or the entire spatial map received from an external device. The robot cleaner may use the spatial map received from a robot cleaner of the same type as it is, or use information about objects whose positions are expected to change frequently to update the spatial map. Even when a spatial map is received from a device of a different type than the robot cleaner, the robot cleaner may use a part of or the entire spatial map for the same space to update its spatial map.

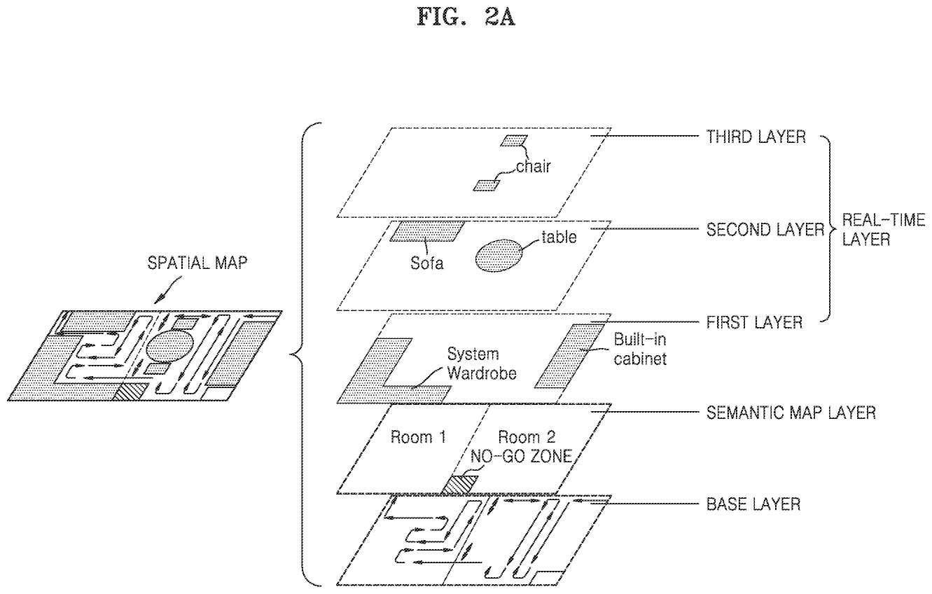

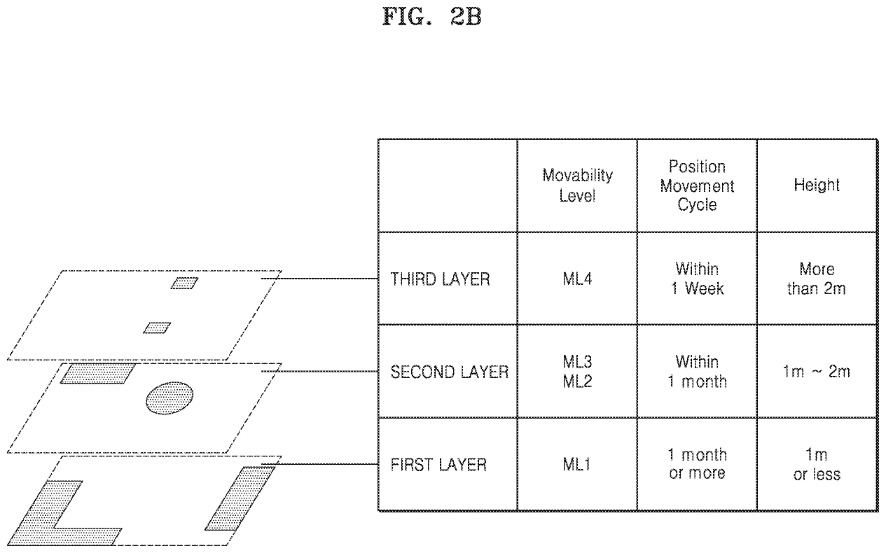

FIGS. 2A and 2B are flow diagrams for describing a spatial map according to an embodiment of the disclosure.

FIG. 2A illustrates a spatial map stored in the electronic device 100, which is a robot cleaner, and a hierarchical structure between a plurality of layers constituting the spatial map.

Referring to FIG. 2A, the spatial map may be composed of, but is not limited to, a base layer, a semantic map layer, and a real-time layer, and layers may be added or omitted depending on characteristics of a task.

The base layer provides information about a basic structure of the entire space, such as walls, columns, and passages. By processing three-dimensional (3D) point cloud data to match the 3D point cloud data to a coordinate system and storing positions, the base layer may provide 3D information about the space, position information about an object, movement trajectory information, etc. The base layer serves as a base map and a geometric map.

The semantic map layer is a layer that provides semantic information on top of the base layer. A user of the electronic device 100 may assign semantic information, such as ‘Room 1,’ ‘Room 2,’ ‘No-Go Zone,’ etc., to the basic structure of the entire space in the base layer, and utilize the semantic information to perform a task on the electronic device 100. For example, when the electronic device 100 is a robot cleaner, the user may set semantic information in the semantic map layer so that the robot cleaner may clean only ‘Room 2’ or not clean the ‘No-Go Zone’.

The real-time layer is a layer that provides information about at least one object in the space. Objects may include both static and dynamic objects. In the disclosure, the real-time layer may include a plurality of layers based on attribute information about an object and have a hierarchical structure between the layers. Referring to FIG. 2A, the real-time layer may include, but is not limited to, a first layer, a second layer, and a third layer, and the number of layers may be increased or decreased according to a classification criterion for attribute information about an object. As seen on FIG. 2A, the first layer may include a system wardrobe and a built-in cabinet, the second layer may include a table and a sofa, and the third layer may include chairs.

FIG. 2B illustrates various examples of a real-time layer including a plurality of layers based on attribute information about an object.

Attribute information about an object may be information may be objective criteria such as a type, shape, size, height, etc. of the object or information that may be classified by combining a plurality of criteria. Furthermore, because attribute information about an object may vary depending on a user and an environment, the attribute information may be input by labeling each object.

According to an embodiment of the disclosure, when attribute information about an object is a mobility level (ML) of the object, the first layer may include an object corresponding to ML 1, the second layer may include objects corresponding to ML 2 and ML 3, and the third layer may include an object corresponding to ML 4. The ML of an object may be determined by applying objective characteristics of the object to a predetermined classification criterion for evaluating mobility. For example, ML 1 corresponds to an immovable object, ML 2 corresponds to an object that is movable but mostly remains stationary, ML 3 corresponds to an object that is movable but is occasionally moved, and ML 4 corresponds to an object that is movable and is frequently moved.

According to an embodiment of the disclosure, when attribute information about an object is a position movement cycle of the object, the first layer may include an object whose position has not been moved within one month, the second layer may include an object whose position has been moved within one month, and the third layer may include an object whose position has been moved within a week. Unlike the ML classified based on the objective characteristics of the object, the position movement cycle may be different even for the same object, depending on a user using the object or an environment in which the object is located. For example, an object ‘A’ may be an object that is frequently used by a first user, but is rarely used by a second user. An object ‘B’ may be an object that is frequently used in a first place, but is rarely used in a second place.

According to an embodiment of the disclosure, when attribute information about an object is a height at which the object is located, the first layer may include an object corresponding to a height of 1 m or less, the second layer may include an object corresponding to a height that is greater than or equal to 1 m but less than or equal to 2 m, and the third layer may include an object corresponding to a height exceeding 2 m.

According to an embodiment of the disclosure, classification criteria for the plurality of layers included in the real-time layer may be defined by the user. For example, the user may create a spatial map that reflects characteristics of a task by setting a combination of a plurality of types of attribute information about an object for a classification criterion. For example, for a robot cleaner, because it generally moves below a height of 50 cm, it is not necessary to consider objects located higher than 1 m, such as a lamp or a picture frame hanging on a wall. Therefore, the user may directly set classification criteria for classifying each layer, so that the first layer includes an object with ML 1 and located 1 m or less, the second layer includes an object with ML 2 or ML 3 and located 1 m or less, and the third layer includes an object with ML 4 and located 1 m or less.

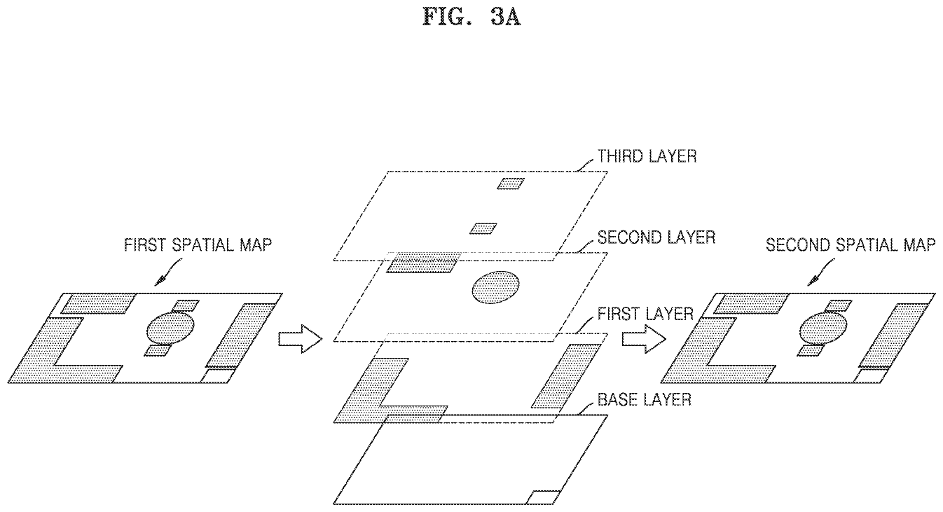

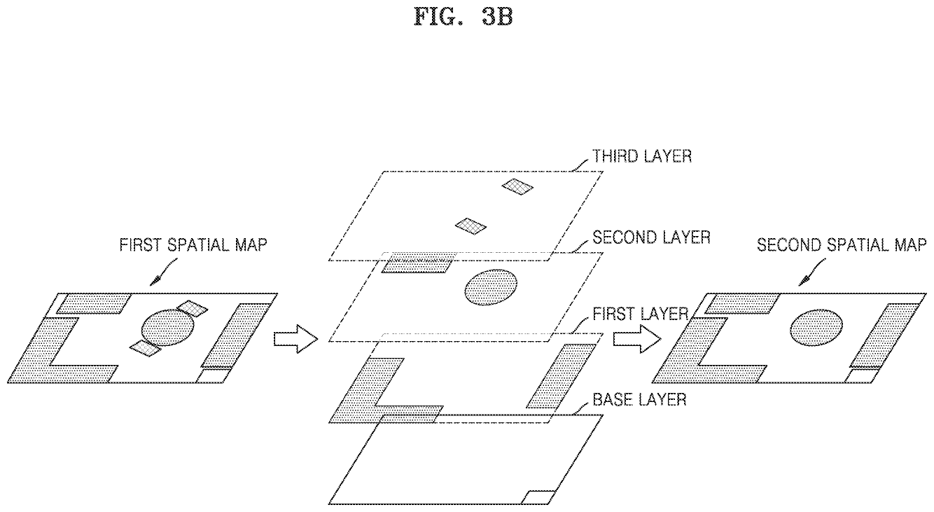

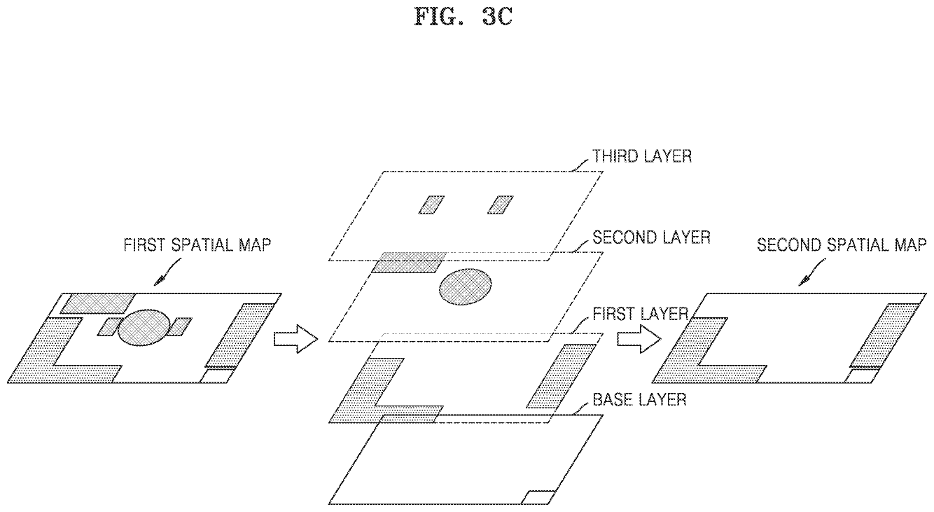

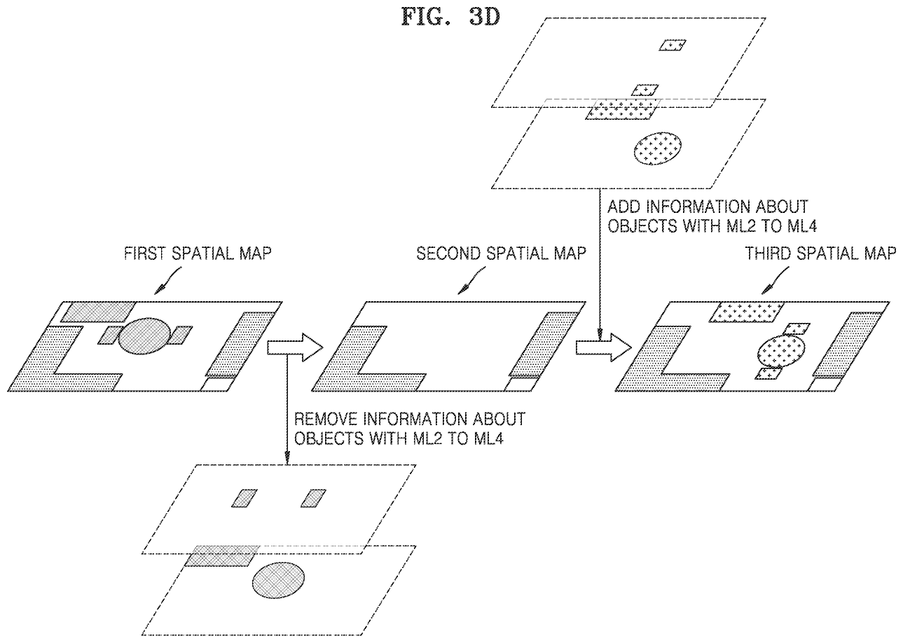

FIGS. 3A, 3B, 3C, and 3D are diagrams for describing a method of utilizing layers constituting a spatial map according to an embodiment of the disclosure.

Spatial maps used in each device may be different depending on types of the electronic device 100 and IoT devices or characteristics of a task. The electronic device 100 may utilize an existing spatial map stored in the electronic device 100, but when a change occurs in a space in which the task is to be performed, the existing spatial map may be updated to reflect the corresponding change. The electronic device 100 may update the existing spatial map by receiving a spatial map that has already reflected changes in the space from at least one external device. The electronic device 100 may generate a new spatial map based on the existing spatial map.

Referring to FIG. 3A, the electronic device 100 may load a previously stored spatial map (hereinafter, a first spatial map). The first spatial map is composed of a base layer, a first layer, a second layer, and a third layer. Hereinafter, for convenience of description, it is assumed that the first to third layers include objects according to any of the classification criteria shown in FIG. 2B. When the first spatial map was generated only a few minutes ago or there have been no change in the space since the first spatial map was used, the electronic device 100 may utilize the first spatial map as it is to generate a new spatial map (hereinafter, referred to as a second spatial map) and use the second spatial map to perform a new task.

Referring to FIG. 3B, the electronic device 100 may load a stored first spatial map. When in performing a task, the electronic device 100 does not need information about an object with ML 4 that is frequently moved or only uses information about an object that has not been moved for a week or longer, the electronic device 100 may obtain a second spatial map by selecting a base layer, a first layer, and a second layer from among layers constituting the first spatial map or removing a third layer from the first spatial map.

Referring to FIG. 3C, the electronic device 100 may load a stored first spatial map. When in performing a new task, the electronic device 100 needs only information about an object with ML 1 or uses only information about an object that has not been moved for one month or longer, the electronic device 100 may obtain a second spatial map by selecting a base layer and a first layer from among layers constituting the first spatial map or removing a second layer and a third layer from the first spatial map.

Referring to FIG. 3D, the electronic device 100 may load a stored first spatial map. When the electronic device 100 performs a new task and it is necessary to reflect latest information about movable objects corresponding to ML 2, ML 3, and ML 4, the electronic device 100 may obtain a second spatial map by selecting a base layer and a first layer from among layers constituting the first spatial map or removing a second layer and a third layer from the first spatial map. Thereafter, the electronic device 100 may obtain a third spatial map by extracting a second layer and a third layer from a spatial map received from an external device and reflecting them in the second spatial map. Alternatively, objects corresponding to ML 2, ML 3, and ML 4 may be detected using at least one sensor provided in the electronic device 100 and reflected in the second spatial map to obtain a third spatial map.

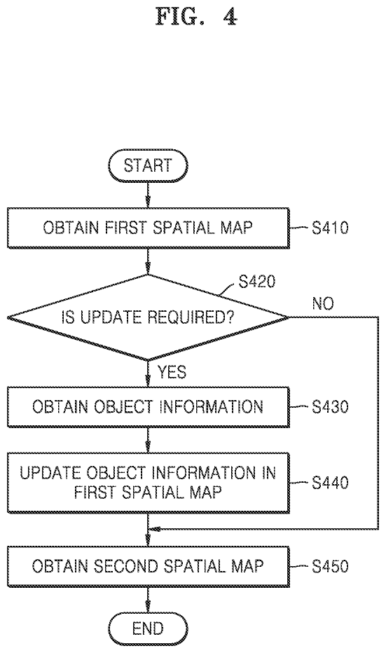

FIG. 4 is a flowchart of a method of obtaining a spatial map, according to an embodiment of the disclosure.

The electronic device 100 may obtain a first spatial map at operation S410. The first spatial map may be composed of a plurality of layers based on attribute information about an object. The first spatial map may be generated by the electronic device 100 or received from a device external to the electronic device 100.

The electronic device 100 may determine whether an update of the first spatial map is required at operation S420. For example, the electronic device 100 may determine whether an update of the first spatial map is required based on characteristics of a task. The task refers to a task that the electronic device 100 is set to perform through a unique purpose of the electronic device 100 or a function that may be executed by the electronic device 100. Setting information related to performing the task may be directly input to the electronic device 100 by the user or may be transmitted to the electronic device 100 via a terminal such as a mobile device or a dedicated remote controller. For example, when the electronic device 100 is a robot cleaner, the task of the robot cleaner may be cleaning of the house or a zone set by the user, scheduled cleaning based on a scheduling function, quiet mode cleaning, etc. When information used to perform the task is insufficient, the electronic device 100 may determine that an update of the first spatial map is required. The electronic device 100 may determine that an update of the first spatial map is required when latest information about an object in a space in which the task is to be performed is required. Alternatively, the electronic device 100 may determine whether an update of the first spatial map is required according to a time elapsed since the first spatial map was obtained or a set update cycle. When no update of the first spatial map is required, the electronic device 100 may utilize the first spatial map as a second spatial map used to perform the task.

When the update of the first spatial map is required, the electronic device 100 may obtain object information at operation S430. The electronic device 100 may directly collect spatial scan information or object information by using at least one sensor. The electronic device 100 may receive, from an external device, a part of or the entire spatial map, or spatial scan information or object information.

The electronic device 100 may update spatial scan information or object information in the first spatial map by using the obtained spatial scan information or object information at operation S440. For example, for a frequently moved object, the electronic device 100 may newly obtain information about the object and spatial scan information about a location where the corresponding object is located and update the newly obtained information about the object or spatial scan information in the first spatial map so that latest location information is reflected in the first spatial map.

The electronic device 100 may obtain a second spatial map at operation S450. The electronic device 100 may obtain the second spatial map by utilizing the first spatial map as it is, utilizing the first spatial map in a modified form with some of the object information or some of the layers modified, or by updating the first spatial map.

Moreover, the second spatial map used to perform the task may be modified into or generated as an appropriate form of map and utilized, depending on a function of the electronic device 100 or the characteristics of the task. For example, when the electronic device 100 is a robot cleaner, the robot cleaner may generate a navigation map based on a spatial map and perform cleaning along a movement path provided by the navigation map.

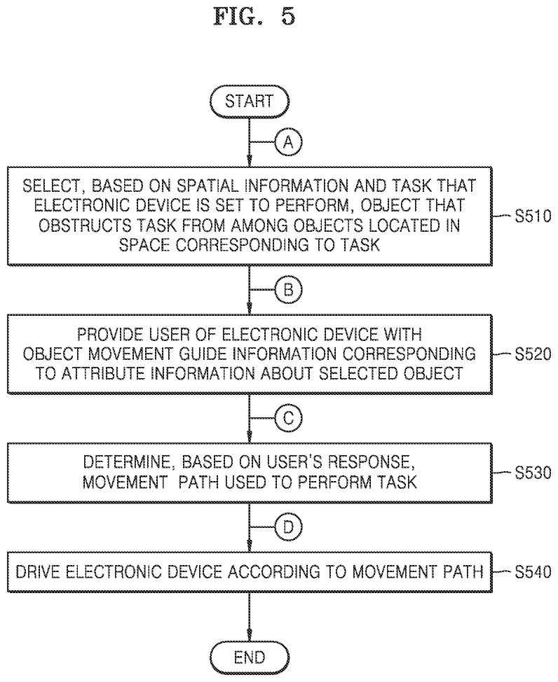

FIG. 5 is a flowchart of a method of controlling the electronic device 100 by using spatial information, according to an embodiment of the disclosure.

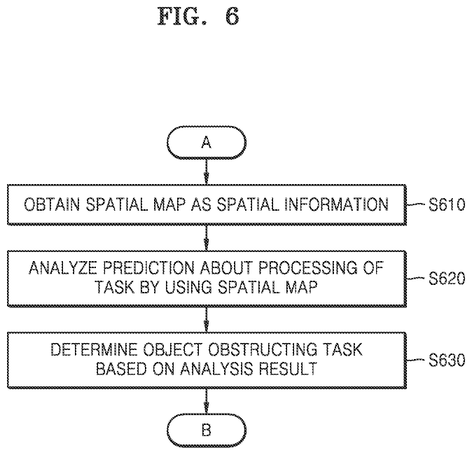

The electronic device 100 may select, based on spatial information about a space including at least one object and a task that the electronic device 100 is set to perform, an object that obstructs the task from among objects located in a space corresponding to the task at operation S510. The spatial information may be a spatial map of the space including the at least one object. The task that the electronic device 100 is set to perform may be determined by the user inputting a job to be processed to the electronic device 100 or setting the electronic device 100 to do the job through the purpose of the electronic device 100 or a function that may be executed by the electronic device 100. The user of the electronic device 100 may directly input settings related to the task to the electronic device 100 or transmit a control command related to the task to the electronic device 100 via a user terminal. For example, when the electronic device 100 is a robot cleaner, a task that the robot cleaner is set to perform may be to clean a space specified by the user as a location where the task is to be performed at a specified time when the task is to be performed according to a specified operating mode. For example, the user of the electronic device 100 may set the robot cleaner to perform cleaning of a specific zone, scheduled cleaning according to a scheduling function, or quiet mode cleaning according to an operation mode. Hereinafter, description is provided with reference to FIG. 6.

FIG. 6 is a detailed flowchart illustrating an operation of selecting an object obstructing a task from among objects located in a space corresponding to the task, according to an embodiment of the disclosure.

The electronic device 100 may obtain a spatial map of a space as spatial information about the space including at least one object at operation S610. The electronic device 100 may obtain the spatial map based on at least one of a spatial map stored in the electronic device 100 or a spatial map received from an external device capable of communicating with the electronic device 100. For example, the electronic device 100 may obtain the spatial map according to the method of obtaining a spatial map described above with reference to FIG. 4.

The electronic device 100 may analyze a prediction about processing of a task that the electronic device 100 is set to perform by using the spatial map at operation S620. The electronic device 100 may identify a task that the electronic device is set to perform, and obtain a spatial map corresponding to a location where the task is to be performed. The electronic device 100 may predict and analyze various cases in which a task is performed on the spatial map. The electronic device 100 may compare and analyze results of predictions about processing of the task for a plurality of cases that are distinguished from each other based on a position of at least one object and at least one branch point on a virtual movement path of the electronic device 100 for performing the task.

According to an embodiment of the disclosure, the electronic device 100 may generate a task processing model that considers whether its direction changes at each branch point or a position of each object is moved. For example, the task processing model may take a location of the electronic device 100 as an input, each layer in the task processing model may correspond to a position of an object or a branch point on a virtual movement path, and each node included in each layer may be a location of the electronic device 100 on a virtual movement path based on whether the direction changes or the object is moved at the corresponding position. The task processing model may be designed such that, when moving from each node in each of the layer constituting the task processing model to a node in the next layer, a higher weight is applied to each node as locations on the virtual movement path overlap to a lesser degree. When the task processing model reaches the last layer through at least one node included in each of all the layers constituting the task processing model, it may be determined that the processing of the task is completed. The virtual movement path used to process the task may be tracked based on a location corresponding to each node in the task processing model. The time required to perform the task, the amount of battery required to perform the task, and the degree of completion of the task may be analyzed for each tracked virtual movement path.

According to an embodiment of the disclosure, the electronic device 100 may create various scenarios for processing the task by taking into account whether its direction changes at each branching point or whether the position of each object is moved. For each scenario, the electronic device 100 may perform a simulation of the task on the obtained spatial map for analysis. For each scenario, the electronic device 100 may analyze the time required to perform the task, the amount of battery required to perform the task, the degree of completion of the task, etc.

For example, when the electronic device 100 is a robot cleaner, the robot cleaner may compare the time required for cleaning, the amount of battery required to perform the cleaning, the degree of completion of the cleaning, etc. for each virtual movement path tracked using the task processing model or for each simulated scenario.

The electronic device 100 may determine at least one object obstructing the task based on an analysis result obtained by analyzing the prediction about the processing of the task at operation S630. The electronic device 100 may select a best case according to at least one criterion, i.e., at least one of the time required to process the task, the amount of battery required, or the degree of completion of the task. For example, a case where the least time or smallest amount of battery is required to process the task, a case in which the degree of completion of the task is highest, or a case in which a weighted average where a weight is assigned for each criterion is highest may be selected as the best case. The electronic device 100 may trace back the virtual movement path corresponding to the best case to determine whether there has been a change in a position of an object on the virtual movement path. At this time, at least one object whose position has been moved may be determined as an object obstructing the task.

For example, when the electronic device 100 is a robot cleaner, a best case in which the robot cleaner performs cleaning may be selected according to at least one criterion, such as the time required to complete cleaning, the amount of battery required, an area cleaned out of the total area, etc. The robot cleaner may trace back the virtual movement path corresponding to the best case to determine whether there has been a change in a position of an object on the virtual movement path, and when there has been a change in the position of an object, the robot cleaner may determine at least one object contributing to the selection of the best case to be an object obstructing the task.

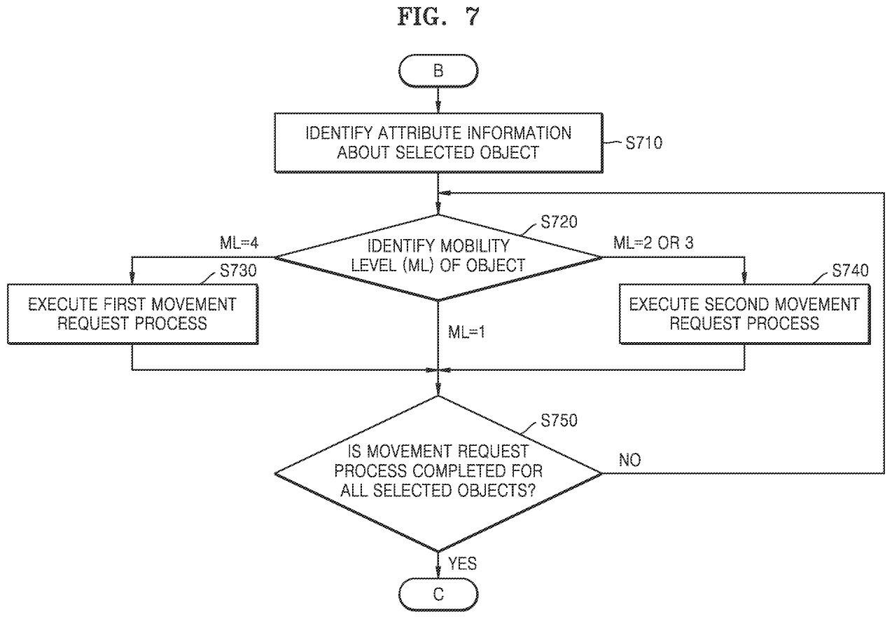

Referring back to FIG. 5, the electronic device 100 may provide the user of the electronic device 100 with object movement guide information corresponding to attributes of the selected object at operation S520, as described below with reference to FIGS. 7 to 13.

FIG. 7 is a detailed flowchart illustrating an operation of providing object movement guide information corresponding to attribute information about an object selected as an object obstructing a task, according to an embodiment of the disclosure.

The electronic device 100 may identify attribute information about the object selected as an object requiring movement in the space where the task is to be performed at operation S710. For example, the electronic device 100 may identify attribute information about the object, based on at least one of a type of the selected object, information about a layer to which the selected object belongs, or a label of the selected object. The electronic device 100 may identify at least one piece of attribute information such as a ML, a position movement cycle, a height, a size, etc. of the selected object.

The electronic device 100 may execute, for all selected objects, a movement request process corresponding to the identified attribute information about the object. The movement request process may include procedures for providing the user with a result of executing a movement request algorithm corresponding to attribute information about the object and confirming a response from the user.

Referring to FIG. 7, considering an example in which the identified attribute information about the object is a ML of the object, the electronic device 100 may identify the ML of the object selected as an object obstructing the task at operation S720. For convenience of description, it is assumed that the attribute information about the object is the ML of the object, but is not limited thereto, and may be other types of attribute information such as a position movement cycle, a height, and a size, etc. of the object. In addition, classification of the identified attribute information is not limited to three cases as shown in FIG. 7, and there may be an appropriate number of classifications according to each attribute information.

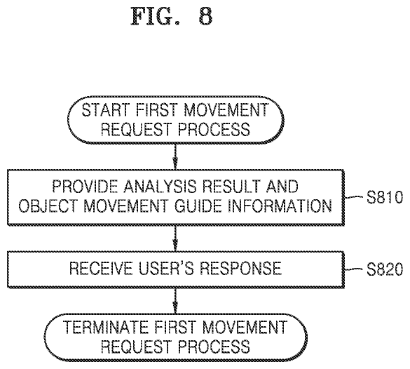

When the ML of the selected object is 4, the electronic device 100 may execute a first movement request process at operation S730, as described below with reference to FIG. 8.

FIG. 8 is a diagram for describing a first movement request process according to an embodiment of the disclosure.

The electronic device 100 may provide the user with an analysis result obtained by analyzing the prediction about the processing of the task and object movement guide information at operation S810. For example, the electronic device 100 may transmit, to the user terminal, an analysis result, which is obtained by analyzing a difference between a result of a case where the object obstructing the task is moved and a result of a case where the object is not moved among results of predictions about the processing of the task, and object movement guide information requesting the movement of the object obstructing the task. When the electronic device 100 is a robot cleaner, the electronic device 100 may provide the user with an analysis result obtained by analyzing a difference in how much cleaning time is reduced or how much a cleanable zone is increased when movement of the selected object is reflected. The electronic device 100 may request the user to move the selected object, and provide the user with information about a suitable position to which the object may be moved.

The electronic device 100 may receive a user's response after providing the analysis result obtained by analyzing the prediction about the processing of the task and the object movement guide information at operation S820. When the electronic device 100 confirms a response from the user, the first movement request process may be terminated. The electronic device 100 may process a response regarding the movement of the object as have been received when the electronic device 100 receives the response regarding movement of the object from the user terminal, or a predetermined time elapses after providing a virtual simulation analysis result to the user terminal and requesting the movement of the object.

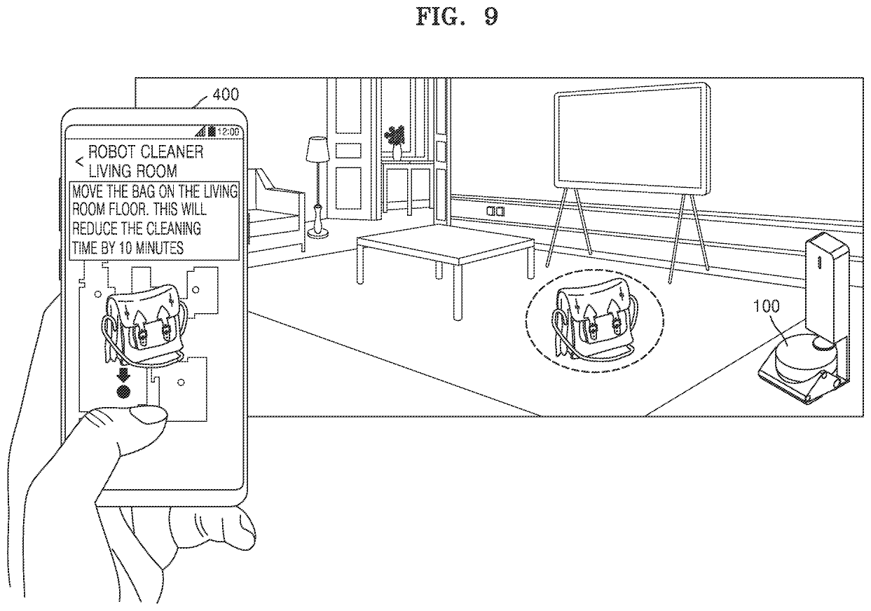

FIG. 9 is a diagram for describing an example of providing object movement guide information to a user, according to an embodiment of the disclosure.

The electronic device 100 may transmit, to a user terminal 400, an analysis result obtained by analyzing a prediction about processing of the task and object movement guide information. For example, the electronic device 100 may transmit, to the user terminal 400, an analysis result, which is obtained by analyzing a difference between a result of a case where the object obstructing the task is moved and a result of a case where the object is not moved among results of predictions about the processing of the task, and object movement guide information requesting the movement of the object obstructing the task.

FIG. 9 illustrates a case in which the electronic device 100 is a robot cleaner and, as a result of analyzing the prediction about the processing of the task, a bag on the floor of the living room is selected as an object obstructing the task.

Referring to FIG. 9, the robot cleaner may transmit a message requesting the user to move the bag on the living room floor, as well as an analysis result obtained by analyzing a difference in how much cleaning time is reduced when the movement of the bag selected as an object obstructing the task is reflected. The message transmitted to the user terminal 400 may further include information about a suitable position to which the bag may be moved.

The robot cleaner may receive a user's response after transmitting to the user terminal 400 the analysis result obtained by analyzing the prediction about the processing of the task and object movement guide information. The robot cleaner may determine that the bag has been moved by receiving, from the user terminal 400, a response indicating that the request for the movement of the bag has been confirmed, or by processing the response as having been received from the user when a predetermined time elapses after requesting the movement of the bag.

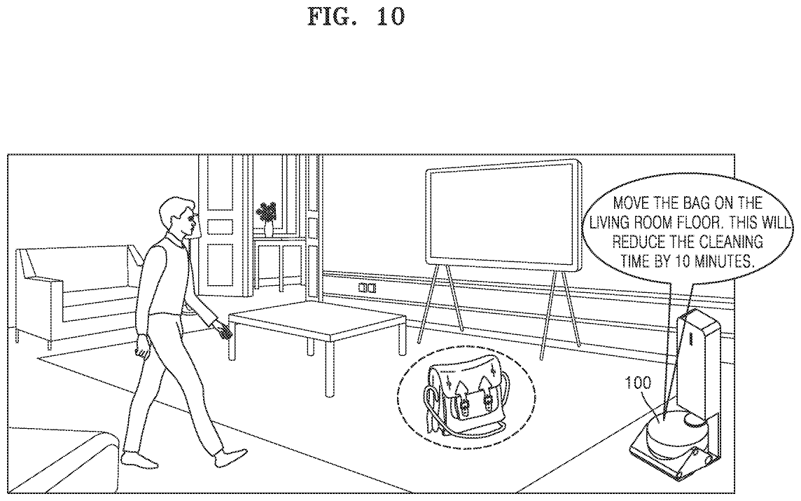

FIG. 10 is a diagram for describing another example of providing object movement guide information to a user, according to an embodiment of the disclosure.

Unlike in the embodiment of FIG. 9, the electronic device 100 may output, in the form of a voice, an analysis result obtained by analyzing the prediction about the processing of the task and object movement guide information. For example, the electronic device 100 may transmit, to the user, in the form of a voice, an analysis result, which is obtained by analyzing a difference between a result of a case where the object obstructing the task is moved and a result of a case where the object is not moved among results of predictions about the processing of the task, and object movement guide information requesting the movement of the object obstructing the task.

In the situation described above with reference to FIG. 9, as shown in FIG. 10, when the movement of the bag selected as an object obstructing the task is reflected, the robot cleaner may transmit, to the user, in the form of a voice, a request to move the bag on the living room floor, as well as the analysis result obtained by analyzing a difference in how much cleaning time is reduced. The robot cleaner may further transmit, in the form of a voice, information about a suitable position to which the bag may be moved in the form of a voice.

The robot cleaner may receive a user's response after outputting, in the form of a voice, the analysis result obtained by analyzing the prediction about the processing of the task and the object movement guide information. The robot cleaner may determine that the bag has been moved by receiving, from the user, a response indicating that the request for the movement of the bag has been confirmed, or by processing the response as having been received from the user when a predetermined time elapses after requesting the movement of the bag.

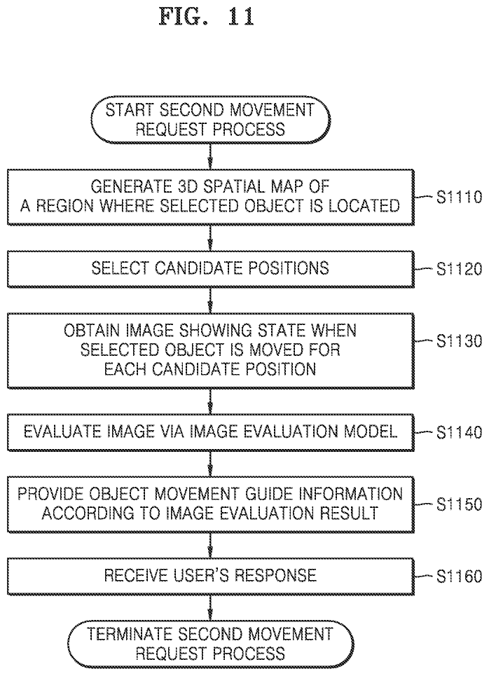

Referring back to FIG. 7, when the ML of the selected object is 2 or 3, the electronic device 100 may execute a second movement request process at operation S740, as described below with reference to FIG. 11.

FIG. 11 is a diagram for describing a second movement request process according to an embodiment of the disclosure.

When the second movement request process starts, the electronic device 100 may generate a 3D spatial map of a region where the selected object is located by using the spatial map at operation S1110. While generating the 3D spatial map, the electronic device 100 may reflect a size of the object selected as an object obstructing the task to thereby secure an area where the selected object may be moved and a space in which the electronic device 100 is to move.

The electronic device 100 may select candidate positions on the generated 3D spatial map, to which the object selected as the object obstructing the task is to be moved at operation S1120. For example, a candidate position may be determined to have a higher priority as the position is closer to a current position of the selected object and does not overlap a user's main movement line.

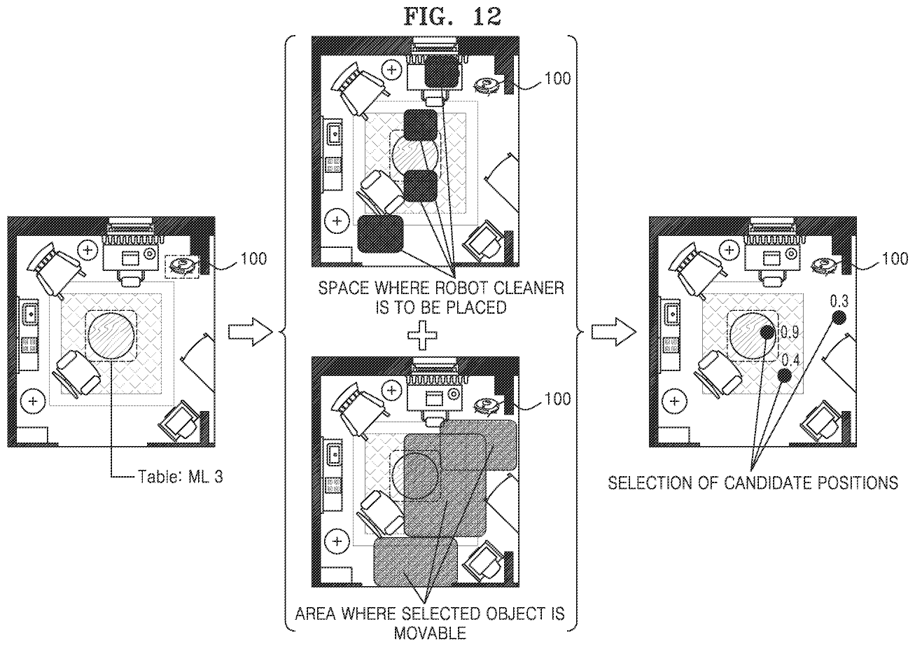

FIG. 12 is a diagram for describing a process of selecting candidate positions to which a selected object is to be moved, according to an embodiment of the disclosure.

Referring to FIG. 12, when the electronic device 100 is a robot cleaner, a process of generating a 3D spatial map corresponding to a place where the robot cleaner is located and selecting candidate positions to which a table selected as an object obstructing the task is to be moved is illustrated. When generating the 3D spatial map, the robot cleaner may identify an area where the table is movable, based on the size of the table and a space where the robot cleaner is to be placed. The robot cleaner may identify areas where the table is movable by securing in advance a space through which the robot cleaner needs to pass in order to perform cleaning. The robot cleaner may select candidate positions of the table in the areas where the table is movable, except for places serving as passages through which the robot cleaner enters or exits. According to a predetermined formula, the closer a candidate position of the table is to a current position of the table, the higher the score assigned thereto. Referring to FIG. 12, it can be seen that the robot cleaner has selected three positions as candidate positions to which the table is to be moved, and scores of ‘0.9’, ‘0.4’, and ‘0.3’ are respectively assigned thereto. The number of candidate positions may be preset, and a criterion for a minimum score to be a candidate position may be adjusted.

Referring back to FIG. 11, the electronic device 100 may obtain, for each candidate position, an image showing a state when the selected object is moved to the corresponding candidate position through image synthesis between the 3D spatial map and the selected object at operation S1130. By using an image synthesis technique, the electronic device 100 may generate an image showing a state when the object selected as the object obstructing the task is moved to a space corresponding to a candidate position on the 3D spatial map.

The electronic device 100 may obtain an image evaluation result via an image evaluation model by inputting an image obtained when the object is moved to the image evaluation model at operation S1140. The image evaluation model may be a model that performs a certain evaluation based on a use of a place where the electronic device 100 is located or settings by the user. According to an embodiment of the disclosure, the image evaluation model may be, but is not limited to, a model that takes as an input an obtained synthesized image of the object that is moved and outputs a result value obtained by scoring an interior aesthetic value. According to an embodiment of the disclosure, the image evaluation model may be a model that takes as an input an obtained synthesized image of the object that is moved and outputs a result value obtained by scoring a safety level of the corresponding space.

The electronic device 100 may provide object movement guide information according to the image evaluation result at operation S1150. For example, when the object selected as the object obstructing the task is moved to a candidate position, the electronic device 100 may provide the user with a recommended position according to an image evaluation result, such as how much interior aesthetic value the corresponding space has or how safe the space is. Based on the image evaluation result, the electronic device 100 may determine, as a recommended position, a candidate position having a high evaluation score among the candidate positions. Alternatively, the electronic device 100 may provide the user with a certain number of candidate positions having high evaluation scores for moving the selected object as recommended positions. The electronic device 100 may receive a user's response after providing the certain number of candidate positions having high evaluation scores (at operation S1160). When the electronic device 100 confirms a response from the user, the second movement request process may be terminated. The electronic device 100 may process a response regarding the movement of the object as have been received when the electronic device 100 receives the response regarding movement of the object from the user terminal, or a predetermined time elapses after providing the certain number of candidate positions having high evaluation scores to the user terminal and requesting the movement of the object.

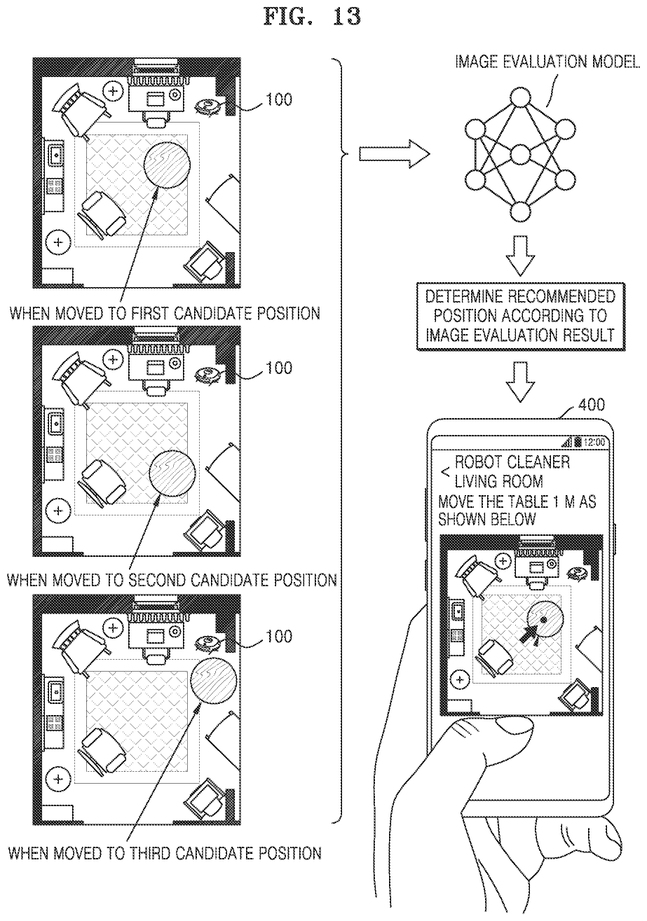

FIG. 13 is a diagram for describing an example of providing a user with object movement guide information according to an image evaluation result, according to an embodiment of the disclosure.

Referring to FIG. 13, when the electronic device 100 is a robot cleaner, the robot cleaner may obtain images respectively showing states in which a table selected as an object obstructing the task is moved to a first candidate position, a second candidate position, and a third candidate position. By synthesizing an image representing a 3D spatial map with an image of the table selected as an object obstructing the task, the robot cleaner may generate an image showing the table located at each candidate position.

The robot cleaner may input an image for each candidate position, which is obtained through image synthesis, to an image evaluation model to thereby obtain an image evaluation result through the image evaluation model. The robot cleaner may provide object movement guide information according to the image evaluation result. Referring to FIG. 13, the robot cleaner may transmit a recommended position based on the image evaluation result to the user terminal 400. The robot cleaner may transmit, to the user terminal 400, an image corresponding to the recommended position among the images for each candidate position, and indicate, on the corresponding image, a direction and a distance of movement from the current position to the recommended position.

Referring back to FIG. 11, the electronic device 100 may receive a user's response after providing the object movement guide information according to the image evaluation result at operation S1160. When the electronic device 100 confirms the response from the user, the second movement request process may be terminated. The electronic device 100 may process a response regarding the movement of the object as have been received when the electronic device 100 receives the response regarding movement of the object from the user terminal 400, or a predetermined time elapses after providing the object movement guide information according to the image evaluation result to the user terminal 400 and requesting the movement of the object.

Referring back to FIG. 7, when the ML of the object is 1, the object is immovable, so the movement request process corresponding to the object may be processed as have been executed even when a certain movement request process is not executed.

The electronic device 100 may check whether the movement request process has been executed for all selected objects at operation S750. The electronic device 100 may repeat the corresponding operation until it identifies attribute information about each object and a corresponding movement request process is executed for all the selected objects.

Moreover, the electronic device 100 may generate a 3D spatial map of a region where the object selected as an object obstructing the task is located to identify an area where the selected object may be moved and a space in which the electronic device 100 is to move. The electronic device 100 may select at least one candidate position on the generated 3D spatial map, to which the object selected as the object obstructing the task is to be moved. The electronic device 100 may move the object selected as the object obstructing the task to one of the candidate positions. For example, when the user has set the electronic device 100 in advance not to receive object movement guide information, or when an object is sufficiently movable by the electronic device 100, the electronic device 100 may move the object selected as the object obstructing the task to a candidate position. When moving the object in this way, the electronic device 100 may obtain a movement path used to perform the task by using the position to which the object is moved as a starting point for the movement path, or perform the process again from reselecting an object that obstructs the task at the position where the object has been moved.

Referring back to FIG. 5, the electronic device 100 may obtain a movement path used to perform the task, based on a user's response corresponding to the object movement guide information at operation S530.

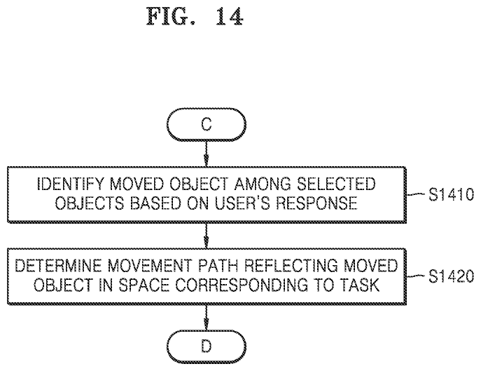

FIG. 14 is a detailed flowchart illustrating an operation of determining a movement path used to perform a task, according to an embodiment of the disclosure.

The electronic device 100 may identify a moved object among the selected objects based on a user's response corresponding to the object movement guide information at operation S1410. In addition to the actually moved object, the electronic device 100 may process a selected object as have been moved when receiving confirmation of movement of the object from the user. The electronic device 100 may process the selected object as not having been moved when the electronic device 100 receives a response indicating rejection of the movement of the selected object from the user, or when a predetermined time elapses without a response from the user after requesting the movement of the selected object from the user terminal.

The electronic device 100 may determine a movement path reflecting the moved object in the space corresponding to the task at operation S1420. For example, the electronic device 100 may generate a navigation map. The navigation map may provide a movement path used by the electronic device 100 to perform the task.

Referring back to FIG. 5, the electronic device 100 may drive the electronic device 100 according to the movement path at operation S540. The electronic device 100 may perform the task while moving along the movement path provided by the navigation map.

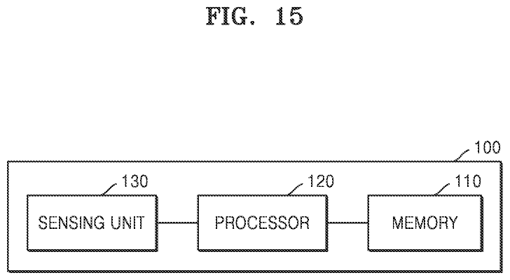

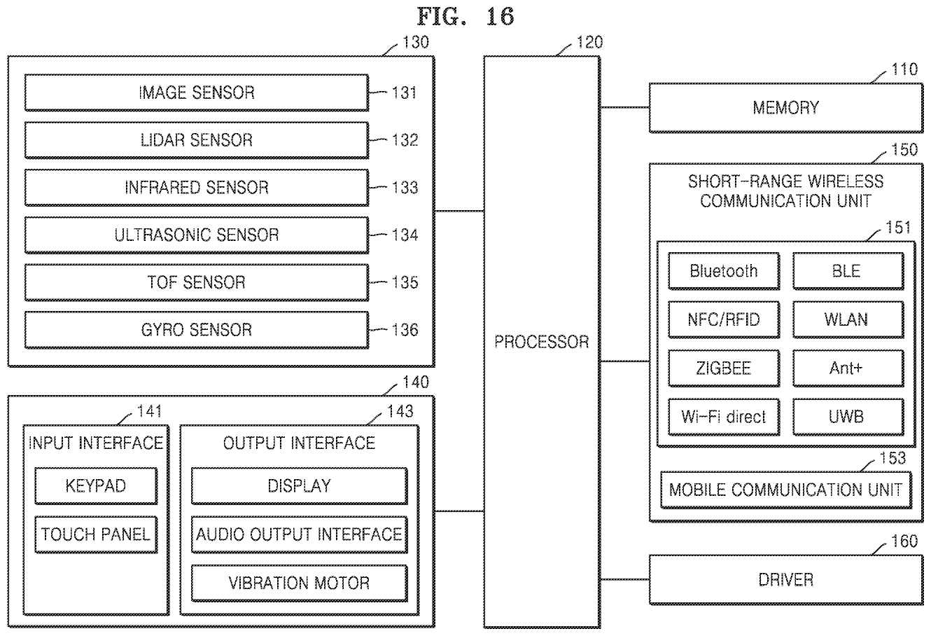

FIGS. 15 and 16 are block diagrams illustrating the configuration of the electronic device 100 using spatial information, according to an embodiment of the disclosure.

Referring to FIG. 15, according to an embodiment of the disclosure, the electronic device 100 may include a memory 110, a processor 120, and a sensor unit 130, but is not limited thereto, and more general-purpose components may be added. For example, referring to FIG. 16, the electronic device 100 may further include an input/output (I/O) interface 140, a communication interface 150, and a driver 160 in addition to the memory 110, the processor 120, and the sensor unit 130. The components are described with reference to FIGS. 15 and 16.

According to an embodiment of the disclosure, the memory 110 may store programs necessary for processing or control by the processor 120, and store data (e.g., spatial information, object information, spatial maps, movement paths, etc.) input to or output from the electronic device 100. The memory 110 may store instructions, data structures, and program code readable by the processor 120. In an embodiment of the disclosure, operations performed by the processor 120 may be implemented by executing instructions or code of a program stored in the memory 110.

According to an embodiment of the disclosure, the memory 110 may include a flash memory-type memory, a hard disk-type memory, a multimedia card micro-type memory, and a card-type memory (e.g., an SD card or an XD memory), and include non-volatile memories including at least one of read-only memory (ROM), electrically erasable programmable ROM (EEPROM), PROM, magnetic memory, magnetic disc, or optical disc, and volatile memories, such as random access memory (RAM) or static RAM (SRAM).

According to an embodiment of the disclosure, the memory 110 may store one or more instructions and/or programs for controlling the electronic device 100 using spatial information to perform a task. For example, a spatial information management module, a task processing module, a driving module, and the like may be stored in the memory 110.

According to an embodiment of the disclosure, the processor 120 may execute instructions or programmed software modules stored in the memory 110 to control operations or functions so that the electronic device 100 may perform a task. The processor 120 may consist of hardware components for performing arithmetic, logic and I/O operations and signal processing. The processor 120 may execute one or more instructions stored in the memory 110 to control all operations in which the electronic device 100 performs a task using spatial information. The processor 120 may execute programs stored in the memory 110 to control the sensor unit 130, the I/O interface 140, the communication interface 150, and the driver 160.

For example, according to an embodiment of the disclosure, the processor 120 may consist of, but is not limited to, at least one of a CPU, a microprocessor, a GPU, application specific integrated circuits (ASICs), DSPs, digital signal processing devices (DSPDs), programmable logic devices (PLDs), field programmable gate arrays (FPGAs), an AP, an NPU, or a dedicated AI processor designed with a hardware structure specialized for processing an AI model. Each processor constituting the processor 120 may be a dedicated processor for performing a predetermined function.

According to an embodiment of the disclosure, an AI processor may perform computations and control using an AI model in order to perform a task that the electronic device 100 is set to perform. The AI processor may be manufactured in the form of a dedicated hardware chip for AI, or it may be manufactured as a part of a general-purpose processor (e.g., a CPU or an AP) or a dedicated graphics processor (e.g., a GPU) and mounted in the electronic device 100.

According to an embodiment of the disclosure, the sensor unit 130 may include a plurality of sensors configured to detect information about an environment around the electronic device 100. For example, the sensor unit 130 may include an image sensor 131, a LiDAR sensor 132, an infrared sensor 133, an ultrasonic sensor 134, a ToF sensor 135, a gyro sensor 136, etc., but is not limited thereto.

According to an embodiment of the disclosure, the image sensor 131 may include a stereo camera, a mono camera, a wide angle camera, an around view camera, or a 3D vision sensor.

The LiDAR sensor 132 may emit laser light onto a target to detect a distance to the object and various physical properties. The LiDAR sensor 132 may be used to detect surrounding objects, terrain features, etc., and model them into 3D images.

The infrared sensor 133 may be any one of an active infrared sensor that radiates infrared light and detects changes by blocking light, and a passive infrared sensor that does not have a light emitter and detects only changes in infrared light received from an outside source. For example, an infrared proximity sensor may be installed around a wheel of the electronic device 100 and may be used as a fall prevention sensor by emitting infrared light to the floor and receiving the reflected infrared light.

The ultrasonic sensor 134 may measure a distance to an object by using ultrasonic waves, and emit and detect ultrasonic pulses that convey information about an object's proximity. The ultrasonic sensor 134 may be used for detecting a nearby object and detecting a transparent object.

The ToF sensor 135 may obtain a 3D effect, movement, and spatial information of an object by calculating a distance based on a time that it takes for light emitted toward the object to bounce back off the object. The ToF sensor 135 may provide high-level object recognition in complex spaces, dark places, and even obstacles in front of the eyes, thereby allowing the electronic device 100 to avoid obstacles.

The gyro sensor 136 may detect an angular velocity. The gyro sensor 136 may be used for measuring a position of the electronic device 100 or and setting a direction thereof.

According to an embodiment of the disclosure, the sensor unit 130 may be used to generate spatial information about a space including at least one object by using at least one sensor. For example, the electronic device 100 may obtain spatial information about a space including at least one object by obtaining spatial scan information or object information using a plurality of sensors of the same or different types among the image sensor 131, the LiDAR sensor 132, the infrared sensor 133, the ultrasonic sensor 134, the ToF sensor 135 and the gyro sensor 136.

Referring to FIG. 16, the electronic device 100 may further include the I/O interface 140, the communication interface 150, and the driver 160, and although not shown in FIG. 16, it may further include a component such as a power supply.

The I/O interface 140 may include an input interface 141 and an output interface 143. The I/O interface 140 may have the input interface 141 and the output interface 143 separated from each other, or may be a single integrated component such as a touch screen. The I/O interface 140 may receive input information from a user and provide output information to the user.

The input interface 141 may refer to a device via which the user inputs data for controlling the electronic device 100. The input interface may include, for example, a keypad, a touch panel (a capacitive overlay type, a resistive overlay type, an infrared beam type, a surface acoustic wave type, an integral strain gauge type, a piezoelectric type, etc.), etc. In addition, the input interface 141 may include a jog wheel, a jog switch, etc., but is not limited thereto.

The output interface 143 may output an audio signal or a video signal, or a vibration signal, and may include a display, an audio output interface, and a vibration motor.

The display may display information processed by the electronic device 100. For example, the display may display a user interface for receiving a user's manipulation. When the display and the touch pad form a layer structure to construct a touch screen, the display may serve as an input device as well as an output device. The display may include at least one of a liquid crystal display (LCD), a thin-film-transistor LCD (TFT LCD), an organic light-emitting diode (OLED) display, a flexible display, or a 3D display. The electronic device 100 may include two or more displays according to its implemented configuration.

The audio output interface may output audio data stored in the memory 110. The audio output interface may also output sound signals related to functions performed by the electronic device 100. The audio output interface may include a speaker, a buzzer, and the like.

The vibration motor may output a vibration signal. For example, the vibration motor may output a vibration signal corresponding to an output of audio data or video data. The vibration motor may output a vibration signal when a touch is input to a touch screen.

The communication interface 150 may include one or more components that enable the electronic device 100 to communicate with external devices such as the cloud server 200, the IoT devices (e.g., 300-1, 300-2, and 300-3), and the user terminal 400. For example, the communication interface 150 may include a short-range wireless communication unit 151, a mobile communication unit 153, etc., but is not limited thereto.

The short-range wireless communication unit 151 may include, but is not limited to, a Bluetooth communication module, a Bluetooth Low Energy (BLE) communication module, a near field communication (NFC) module, a wireless local area network (WLAN) (or Wi-Fi) communication module, a ZigBee communication module, an Ant+ communication module, a Wi-Fi direct (WFD) communication module, an ultra-wideband (UWB) communication module, an Infrared Data Association (IrDA) communication module, a microwave (uWave) communication module, etc.

The mobile communication unit 153 transmits or receives wireless signals to or from at least one of a base station, an external terminal, or a server on a mobile communication network. In this case, the wireless signals may include a voice call signal, a video call signal, or various forms of data according to transmission and reception of text/multimedia messages.

The driver 160 may include components used for driving (traveling) the electronic device 100 and operating devices inside the electronic device 100. When the electronic device 100 is a robot cleaner, the driver 160 may include a suction unit, a traveling unit, etc., but is not limited thereto.

The suction unit functions to collect dust on the floor while sucking in air, and may include a rotating brush or broom, a rotating brush motor, an air suction port, a filter, a dust collecting chamber, an air discharge port, etc., but is not limited thereto. The suction unit may be additionally equipped with a structure in which brushes capable of sweeping up the dust in corners are rotated.

The traveling unit may include a motor for rotating and driving wheels installed in the electronic device 100 and a timing belt installed to transmit power generated by the wheels, but is not limited thereto.

According to an embodiment of the disclosure, the processor 120 may execute one or more instructions stored in the memory 110 to, based on spatial information about a space including at least one object, which is obtained via the sensor unit 130, and a task that the electronic device 100 is set to perform, select an object that obstructs the task from among objects located in a space corresponding to the task.

The processor 120 may execute the one or more instructions stored in the memory 110 to obtain a spatial map as the spatial information. The processor 120 may execute the one or more instructions stored in the memory 110 to obtain a spatial map based on at least one of a first spatial map stored in the electronic device 100 or a second spatial map received from an external device in communication with the electronic device 100. The spatial map may include a plurality of layers based on attribute information about an object.

The processor 120 may execute the one or more instructions stored in the memory 110 to analyze a result of a prediction about processing of the task by using the obtained spatial map. According to an embodiment of the disclosure, the processor 120 may execute the one or more instructions stored in the memory 110 to compare and analyze results of predictions about the processing of the task for a plurality of movement paths that are distinguished from each other based on a position of at least one object and at least one branch point on a virtual movement path of the electronic device 100 for performing the task. The processor 120 may execute the one or more instructions stored in the memory 110 to determine at least one object obstructing the task based on an analysis result.

According to an embodiment of the disclosure, the processor 120 may execute the one or more instructions stored in the memory 110 to provide a user of the electronic device 100 with object movement guide information corresponding to attribute information about the object selected as the object obstructing the task. The processor 120 may provide the user with the object movement guide information by identifying attribute information about the object selected as the object obstructing the task and executing a movement request process corresponding to the identified attribute information about the selected object.

According to an embodiment of the disclosure, the processor 120 may execute the one or more instructions stored in the memory 110 to transmit, to the user terminal 400 of the user, via the communication interface 150, the analysis result obtained by analyzing the prediction about the processing of the task and the object movement guide information. According to an embodiment of the disclosure, the processor 120 may execute one or more instructions stored in the memory 110 to select, on a 3D spatial map of a region where the object selected as the object obstructing the task, candidate positions to which the selected object is to be moved. The processor 120 may obtain, for each candidate position, an image showing a state when the selected object is moved to the corresponding candidate position and evaluate the obtained image via an image evaluation model by inputting the image to the image evaluation model. The processor 120 may transmit the object movement guide information according to an image evaluation result to the user terminal 400 via the communication interface 150.

According to an embodiment of the disclosure, the processor 120 may execute the one or more instructions stored in the memory 110 to determine a movement path used to perform the task, based on a user's response corresponding to the object movement guide information. According to an embodiment of the disclosure, the processor 120 may identify, based on a user's response, a moved object among the objects selected as the object obstructing the task, and obtain a movement path reflecting the moved object in the space corresponding to the task.

According to an embodiment of the disclosure, the processor 120 may execute the one or more instructions stored in the memory 110 to drive the electronic device 100 according to the determined movement path. When an unexpected object or an object determined to have been moved is detected while the electronic device 100 is traveling along the movement path, the processor 120 may bypass the object and then drive the electronic device 100 again along the movement path, or notify the user of the presence of the corresponding object.

Moreover, an embodiment of the disclosure may be implemented in the form of recording media including instructions executable by a computer, such as a program module executable by the computer. The computer-readable recording media may be any available media that are accessible by the computer, and include both volatile and non-volatile media and both removable and non-removable media. Furthermore, the computer-readable recording media may include computer storage media and communication media. The computer storage media include both volatile and non-volatile and both removable and non-removable media implemented in any method or technology for storage of information, such as computer-readable instructions, data structures, program modules, or other data. The communication media may typically include computer-readable instructions, data structures, program modules, or other data in a modulated data signal.

A computer-readable storage medium may be provided in the form of a non-transitory storage medium. In this regard, the term ‘non-transitory storage medium’ only means that the storage medium does not include a signal (e.g., an electromagnetic wave) and is a tangible device, and the term does not differentiate between where data is semi-permanently stored in the storage medium and where the data is temporarily stored in the storage medium. For example, the ‘non-transitory storage medium’ may include a buffer for temporarily storing data.

According to an embodiment of the disclosure, a method according to the embodiment of the disclosure may be included in a computer program product when provided. The computer program product may be traded, as a product, between a seller and a buyer. The computer program product may be distributed in the form of a computer-readable storage medium (e.g., compact disc ROM (CD-ROM) or distributed (e.g., downloaded or uploaded) on-line via an application store or directly between two user devices (e.g., smartphones). For online distribution, at least a part of the computer program product (e.g., a downloadable app) may be at least transiently stored or temporally generated in the computer-readable storage medium such as a memory of a server of a manufacturer, a server of an application store, or a relay server.

According to an embodiment of the disclosure, a method of controlling the electronic device 100 by using spatial information is provided. The method of controlling the electronic device 100 by using spatial information may include, based on spatial information about a space including at least one object and a task that the electronic device 100 is set to perform, selecting an object that obstructs the task from among objects located in a space corresponding to the task at operation 8510. Furthermore, the method of controlling the electronic device 100 by using spatial information may include providing a user of the electronic device 100 with object movement guide information corresponding to attribute information about the selected object at operation 8520. Furthermore, the method of controlling the electronic device 100 by using spatial information may include determining a movement path used to perform the task, based on a user's response corresponding to the object movement guide information at operation 8530. Furthermore, the method of controlling the electronic device 100 by using spatial information may include driving the electronic device 100 according to the determined movement path at operation 8540.

Furthermore, according to an embodiment of the disclosure, the selecting of the object obstructing the task at operation S510 includes obtaining a spatial map as the spatial information at operation 8610. Furthermore, the selecting of the object obstructing the task at operation 8510 includes analyzing a prediction about processing of the task by using the obtained spatial map at operation 8620. Furthermore, the selecting of the object obstructing the task at operation S510 includes determining at least one object obstructing the task based on an analysis result obtained by the analyzing at operation 8630.

Furthermore, the obtaining of the spatial map at operation S610 includes obtaining a spatial map based on at least one of a first spatial map stored in the electronic device 100 or a second spatial map received from an external device in communication with the electronic device 100.

Furthermore, the analyzing of the prediction at operation S620 includes comparing and analyzing results of predictions about the processing of the task for a plurality of movement paths that are distinguished from each other based on a position of at least one object and at least one branch point on a virtual movement path of the electronic device 100 for performing the task.

Furthermore, according to an embodiment of the disclosure, the providing of the object movement guide information to the user of the electronic device 100 at operation S520 includes identifying attribute information about the selected object at operation S710. Furthermore, the providing of the object movement guide information to the user of the electronic device 100 at operation S520 includes providing the object movement guide information to the user by executing a movement request process corresponding to the identified attribute information about the selected object at operations S720, S730, S740, and S750.

Furthermore, the providing to the user at operation S730 includes transmitting, to a user terminal of the user, a result of analyzing prediction about the processing of the task and the object movement guide information at operation S810.

Furthermore, the providing to the user at operation S740 includes selecting, on a 3D spatial map of a region where the selected object is located, candidate positions to which the selected object is to be moved at operations S1110 and S1120. Furthermore, the providing to the user at operation S740 includes obtaining, for each candidate position, an image showing a state when the selected object is moved to a corresponding candidate position at operation S1130. Furthermore, the providing to the user at operation S740 includes evaluating the obtained image via an image evaluation model by inputting the image to the image evaluation model at operation S1140. Furthermore, the providing to the user at operation S740 includes transmitting, to the user terminal of the user, the object movement guide information according to a result of the evaluating of the obtained image at operation S1150.

Furthermore, according to an embodiment of the disclosure, the determining of the movement path at operation S530 includes identifying, based on a user's response, a moved object among the selected objects at operation S1410. Furthermore, the determining of the movement path at operation S530 includes obtaining a movement path reflecting the moved object in the space corresponding to the task at operation S1420.

In addition, according to an embodiment of the disclosure, the electronic device 100 is a robot cleaner.

According to an embodiment of the disclosure, a computer-readable recording medium having recorded thereon a program for executing the above-described method may be provided.

According to an embodiment of the disclosure, the electronic device 100 using spatial information is provided. The electronic device 100 using spatial information includes the memory 110, the processor 120 configured to execute one or more instructions stored in the memory 110, and the sensor unit 130. The processor 120 executes the one or more instructions to, based on spatial information about a space including at least one object, which is obtained via the sensor unit 130, and a task that the electronic device 100 is set to perform, select an object that obstructs the task from among objects located in a space corresponding to the task. Furthermore, the processor 120 executes the one or more instructions to provide a user of the electronic device 100 with object movement guide information corresponding to attribute information about the selected object. Furthermore, the processor 120 executes the one or more instructions to determine a movement path used to perform the task, based on a user's response corresponding to the object movement guide information. Furthermore, the processor 120 executes the one or more instructions to drive the electronic device 100 according to the determined movement path.

Furthermore, according to an embodiment of the disclosure, the processor 120 executes the one or more instructions to obtain a spatial map as the spatial information. Furthermore, the processor 120 executes the one or more instructions to analyze a prediction about processing of the task by using the obtained spatial map. Furthermore, the processor 120 executes the one or more instructions to determine at least one object obstructing the task based on an analysis result obtained by the analyzing.

Furthermore, the processor 120 executes the one or more instructions to obtain a spatial map based on at least one of a first spatial map stored in the electronic device 100 or a second spatial map received from an external device capable of communicating with the electronic device 100.

Furthermore, the processor 120 executes the one or more instructions to compare and analyze results of predictions about the processing of the task for a plurality of movement paths that are distinguished from each other based on a position of at least one object and at least one branch point on a virtual movement path of the electronic device 100 for performing the task.

Furthermore, the spatial map includes a plurality of layers based on attribute information about an object.

Furthermore, according to an embodiment of the disclosure, the processor 120 executes the one or more instructions to identify attribute information about the selected object. Furthermore, the processor 120 executes the one or more instructions to provide the object movement guide information to the user by executing a movement request process corresponding to the identified attribute information about the object.

Furthermore, the electronic device 100 may further include the communication interface 150. Furthermore, the processor 120 executes the one or more instructions to transmit, to the user terminal 400 of the user, via the communication interface 150, the result of the analyzing of the prediction about the processing of the task and the object movement guide information.

Furthermore, the electronic device 100 may further include the communication interface 150. Furthermore, the processor 120 executes the one or more instructions to select, on a 3D spatial map of a region where the selected object is located, candidate positions to which the selected object is to be moved. Furthermore, the processor 120 executes the one or more instructions to obtain an image showing a state when the selected object is moved for each candidate position. Furthermore, the processor 120 executes the one or more instructions to evaluate the obtained image via an image evaluation model by inputting the image to the image evaluation model. Furthermore, the processor 120 executes the one or more instructions to transmit the object movement guide information according to a result of the evaluating of the image to the user terminal 400 of the user via the communication interface 150.

Furthermore, according to an embodiment of the disclosure, the processor 120 executes the one or more instructions to identify, based on a user's response, a moved object among the selected objects. Furthermore, the processor 120 executes the one or more instructions to obtain a movement path reflecting the moved object in the space corresponding to the task.

In addition, according to an embodiment of the disclosure, the electronic device 100 is a robot cleaner.

The above description of the disclosure is provided for illustration, and it will be understood by one of ordinary skill in the art that changes in forms or details may be readily made therein without departing from technical idea or essential features of the disclosure. Accordingly, it should be understood that the above-described embodiment of the disclosure and all aspects thereof are merely examples and are not limiting. For example, each component defined as an integrated component may be implemented in a distributed fashion, and likewise, components defined as separate components may be implemented in an integrated form.

While the disclosure has been shown and described with reference to an embodiment thereof, it will be understood by those skilled in the art that various changes in form and details may be made therein without departing from the spirit and scope of the disclosure as defined by the appended claims and their equivalents.

What is claimed is:

1. A method of controlling an electronic device by using spatial information, the method comprising:
based on spatial information about a space including at least one object and a task that the electronic device is set to perform, selecting an object that obstructs the task from among objects located in a space corresponding to the task;
providing a user of the electronic device with object movement guide information corresponding to attribute information about the selected object;
determining a movement path used to perform the task, based on a user's response corresponding to the object movement guide information; and
driving the electronic device according to the determined movement path.

2. The method of claim 1, wherein the selecting of the object obstructing the task comprises:
obtaining a spatial map as the spatial information;
analyzing a prediction about processing of the task by using the obtained spatial map; and
determining at least one object obstructing the task, based on a result of the analyzing.

3. The method of claim 2, wherein the obtaining of the spatial map comprises obtaining the spatial map, based on at least one of a first spatial map stored in the electronic device or a second spatial map received from an external device in communication with the electronic device.

4. The method of claim 2, wherein the analyzing of the prediction comprises comparing and analyzing results of predictions about the processing of the task for a plurality of movement paths that are distinguished from each other based on a position of at least one object and at least one branch point on a virtual movement path of the electronic device for performing the task.

5. The method of claim 1, wherein the providing of the object movement guide information comprises:
identifying attribute information about the selected object; and
providing the object movement guide information to the user by executing a movement request process corresponding to the identified attribute information about the selected object.

6. The method of claim 5, wherein the providing of the object movement guide information comprises transmitting, to a user terminal of the user, an analysis result obtained by analyzing a prediction about processing of the task and the object movement guide information.

7. The method of claim 5, wherein the providing of the object movement guide information comprises:
selecting, on a three-dimensional (3D) spatial map of a region where the selected object is located, candidate positions to which the selected object is to be moved;
obtaining, for each candidate position, an image showing a state when the selected object is moved to a corresponding candidate position;
evaluating the obtained image via an image evaluation model by inputting the image to the image evaluation model; and
transmitting, to a user terminal of the user, the object movement guide information according to a result of the evaluating of the obtained image.

8. The method of claim 1, wherein the determining of the movement path comprises:
identifying, based on the user's response, a moved object among the selected objects; and
obtaining a movement path reflecting the moved object in the space corresponding to the task.

9. The method of claim 1, wherein the electronic device is a robot cleaner.

10. A non-transitory computer-readable recording medium having recorded thereon a program that, when executed by at least one processor, cause the at least one processor to control for:
based on spatial information about a space including at least one object and a task that an electronic device is set to perform, selecting an object that obstructs the task from among objects located in a space corresponding to the task;
providing a user of the electronic device with object movement guide information corresponding to attribute information about the selected object;
determining a movement path used to perform the task, based on a user's response corresponding to the object movement guide information; and
driving the electronic device according to the determined movement path.

11. An electronic device using spatial information, the electronic device comprising:
a memory storing one or more instructions;
a processor configured to execute the one or more instructions stored in the memory; and
a sensor unit,
wherein the processor is configured to execute the one or more instructions to:
based on spatial information about a space including at least one object, which is obtained via the sensor unit, and a task that the electronic device is set to perform, select an object that obstructs the task from among objects located in a space corresponding to the task,
provide a user of the electronic device with object movement guide information corresponding to attribute information about the selected object,
determine a movement path used to perform the task, based on a user's response corresponding to the object movement guide information, and
drive the electronic device according to the determined movement path.

12. The electronic device of claim 11, wherein the processor is further configured to:
obtain a spatial map as the spatial information, analyze a prediction about processing of the task by using the obtained spatial map, and
determine at least one object obstructing the task based on a result of the analyzing.

13. The electronic device of claim 12, wherein the processor is further configured to obtain the spatial map based on at least one of a first spatial map stored in the electronic device or a second spatial map received from an external device in communication with the electronic device.

14. The electronic device of claim 12, wherein the processor is further configured to compare and analyze results of predictions about the processing of the task for a plurality of movement paths that are distinguished from each other based on a position of at least one object and at least one branch point on a virtual movement path of the electronic device for performing the task.

15. The electronic device of claim 12, wherein the spatial map comprises a plurality of layers based on attribute information about an object.

16. The electronic device of claim 11, wherein the processor is further configured to:
identify attribute information about the selected object, and
provide the object movement guide information to the user by executing a movement request process corresponding to the identified attribute information about the selected object.

17. The electronic device of claim 16, further comprising:
a communication interface,
wherein the processor is further configured to transmit, to a user terminal of the user, via the communication interface, an analysis result obtained by analyzing a prediction about processing of the task and the object movement guide information.

18. The electronic device of claim 16, further comprising:
a communication interface,
wherein the processor is further configured to:
select, on a three-dimensional (3D) spatial map of a region where the selected object is located, candidate positions to which the selected object is to be moved,
obtain, for each candidate position, an image showing a state when the selected object is moved to a corresponding candidate position,
evaluate the obtained image via an image evaluation model by inputting the image to the image evaluation model, and
transmit the object movement guide information according to a result of the evaluating of the obtained image to a user terminal of the user via the communication interface.

19. The electronic device of claim 11, wherein the processor is further configured to:
identify, based on the user's response, a moved object among the selected objects, and
obtain a movement path reflecting the moved object in the space corresponding to the task.

20. The electronic device of claim 11, wherein the electronic device is a robot cleaner.
